(19) United States
(12) Patent Application Publication
(10) Pub. No.: US 2024/0296297 A1
(43) Pub. Date: Sep. 5, 2024

(54) SELECTIVE PRE-TRANSLATION OF WEB CONTENT

(71) Applicant: Airbnb, Inc., San Francisco, CA (US)

(72) Inventors: Salvatore GIAMMARRESI, San Francisco, CA (US); Sergio PELINO, San Francisco, CA (US); Hua ZHENG, San Francisco, CA (US); Theresa KOO, San Francisco, CA (US)

(21) Appl. No.: 18/658,712

(22) Filed: May 8, 2024

Related U.S. Application Data
(63) Continuation of application No. PCT/US2022/049293, filed on Nov. 8, 2022.
(60) Provisional application No. 63/263,757, filed on Nov. 8, 2021.

(51) Int. Cl. G06F 40/58; G06F 3/0482

(52) U.S. Cl. CPC G06F 40/58; G06F 3/0482

(57) ABSTRACT

A server obtains content in a first language and receives a first request from a first client device to view the content, wherein the first client device is associated with a second language selected by a user operating the first client device. In response to receiving the first request, the server determines that the first language is different from the second language and determines that a storage of the server does not include a machine-translated version of the content in the second language. In accordance with these determinations, the server obtains a machine-translated version of the content in the second language and stores the machine-translated version of the content in the second language in the storage for subsequent requests to view the content in the second language.

### RELATED APPLICATION

This application is related to U.S. Provisional Patent Application No. 63/263,757, filed Nov. 8, 2021, entitled “Selective Pre-Translation of Web Content,” which is incorporated by reference herein in its entirety.

### TECHNICAL FIELD

This application relates to automated processes for selectively obtaining machine translations for content at a server.

### BACKGROUND

As the world becomes more connected, online business interactions are increasingly taking place among users who speak different languages. Companies that host content on the internet risk losing user engagement if the content is not in the user's language. To account for this, some websites offer a third-party translation service by including a “translate” button with the hosted content. By clicking the button, a user may receive a machine translation of content in a requested language. However, the efficiency with which these services provide the requested translations typically comes at the cost of quality. Further, such translation services typically charge companies on a per-click basis, thereby adding costs to companies that use them, especially companies with large user bases.

### SUMMARY

This disclosure describes a selective pre-translation system and method in which online content is selectively translated based on user activity. Rather than translating an entire body of content, the system and method described herein selectively translate content upon satisfaction of certain activity-based thresholds. When translation processes are triggered based on these thresholds being met, high-quality translations may be obtained, cached, and served to users who subsequently request to view the content in the translated language. As such, the quality of the translated content is increased, user engagement is increased, and translation costs are controlled.

In one aspect, a first viewer automatically triggers a server-based translation process. Specifically, a server is configured to obtaining content in a first language. In one example, the content may be an online listing (e.g., for a room rental); however, any other type of content may be obtained. Before providing the content to a first client device, the server receives a first request from the first client device to view the content, wherein the first request is associated with a second language selected by a user operating the first client device. In response to receiving the first request, the server determines that the first language of the content is different from the second language associated with the first request. In accordance with the determination that the first language of the content is different from the second language associated with the first request, the server obtains a machine-translated version of the content in the second language, and provides the machine-translated version of the content in the second language to one or more client devices.

In some implementations, a second (subsequent) viewer automatically gets the translated content that was previously translated for the first viewer. Specifically, after having obtained the machine-translated version of the content in the second language, the server stores the machine-translated version of the content in the second language in a storage of the server. The server receives a second request from a second client device to view the content, wherein the second request is associated with the second language. In response to receiving the second request, the server determines that the first language of the content is different from the second language associated with the second request, and determines that the storage of the server includes the machine-translated version of the content in the second language. In accordance with the determination that the first language of the content is different from the second language associated with the second request and the determination that the storage of the server includes the machine-translated version of the content in the second language, the server provides the machine-translated version of the content in the second language to the second client device.

In some implementations, obtaining the machine-translated version of the content in the second language is subject to a threshold of requests to view the content in the second language. Specifically, the first request is an Nth request to view the content, and in response to receiving the first request, the server determines that N is greater than or equal to a predetermined threshold for obtaining a machine translation, wherein the predetermined threshold is at least two, and obtains the machine-translated version of the content in the second language in accordance with the determination that N is greater than or equal to the predetermined threshold.

In some implementations, the server adjusts the predetermined threshold based on a cost associated with obtaining the machine-translated version of the content in the second language.

In some implementations, the machine-translated version of the content in the second language is obtained from a machine-translation algorithm based on one or more machine learning processes that are trained using content received at the server.

In some implementations, the content in the first language is user-submitted content obtained from a third client device; and the server determines that the user-submitted content is in the first language based on an association of the first language with the third client device.

In some implementations, in response to receiving the first request, the server determines that the storage of the server does not include a machine-translated version of the content in the second language, and the server obtains the machine-translated version of the content in the second language in accordance with the determination that the storage of the server does not include a machine-translated version of the content in the second language.

In some implementations, prior to receiving the first request from the first client device, the server receives, from the first client device, selection of the second language as the selected language for the first client device, and the server assigns the second language to a profile associated with the user operating the first client device based on the selection of the second language; wherein the association of the first request and the second language is based on the second language being assigned to the profile associated with the user operating the first client device.

In some implementations, prior to receiving the first request from the first client device, the server receives, from the first client device, selection of a locale of the first client device, and the server assigns the second language to a profile associated with the user operating the first client device based on the selection of the locale of the first client device, wherein the association of the first request and the second language is based on the second language being assigned to the profile associated with the user operating the first client device.

In some implementations, subsequent to receiving the first request, the server obtains an update to the content in the first language. In response to obtaining the update to the content in the first language and prior to receiving any subsequent requests to view the content, the server obtains a machine-translated version of the update to the content in the second language, and stores the machine-translated version of the update to the content in the second language in the storage of the server.

In some implementations, in response to receiving the first request, the server provides the content in the first language to the first client device.

In some implementations, providing the content in the first language to the first client device includes providing a machine-translation option to the first client device, and the server receives an indication from the first client device that the machine-translation option was selected. In response to receiving the indication, the server obtains a non-cached machine-translated version of the content in the second language, and provides the non-cached machine-translated version of the content in the second language to the first client device.

In some implementations, in accordance with the determination that the first language of the content is different from the second language indicated by the profile associated with the first client device, the server provides the machine-translated version of the content in the second language to the first client device.

In some implementations, providing the machine-translated version of the content in the second language to the first client device includes providing an original-language option to the first client device, and the server receives an indication from the first client device that the original-language option was selected. In response to receiving the indication, the server provides the content in the first language to the first client device.

### BRIEF DESCRIPTION OF THE DRAWINGS

For a better understanding of the various described implementations, reference should be made to the Detailed Description below, in conjunction with the following drawings. Throughout these drawings, like reference numerals refer to corresponding parts.

FIG. 1 is a block diagram of an online content hosting environment including a server configured to selectively pre-translate content in accordance with some implementations.

FIG. 2 is a block diagram of the server of FIG. 1, including modules configured to implement the selective pre-translation of content in accordance with some implementations.

FIGS. 3A-3B depict content as received at the server of FIG. 1 in one language and viewed by a client device associated with another language in accordance with some implementations.

FIGS. 4A-4B depict content as received at the server of FIG. 1 in one language and viewed by a client device associated with another language, where the content is pre-translated in accordance with some implementations.

FIGS. 5A-5B are timing diagrams of example operating scenarios of the online content hosting environment of FIG. 1 in accordance with some implementations.

FIG. 6 is a flow diagram depicting operations of the online content hosting environment of FIG. 1 in accordance with some implementations.

FIG. 7 is a flow diagram depicting a method of pre-translating content at the server of FIG. 1 in accordance with some implementations.

### DETAILED DESCRIPTION

This disclosure describes an impression-based translation system that detects content being viewed by users associated with languages other than the original language of the content. When at least a predetermined threshold of such users view the content, the system triggers a translation process and stores high quality translations of the content for later views. Subsequent users may be automatically presented with the translated content. As used herein, the term “quality” in the context of translations refers to accuracy, including how accurately understood the content is by a fluent speaker of the translated language. Translation quality takes into account such factors as formal and informal language, idioms, natural spoken phrases, saying, and expressions (e.g., “killer sunset view”) that may not translate accurately using basic machine translations.

In one example, a content creator uploads content to a server in a first language (e.g., Korean). The content is typically written text, although other forms of content are contemplated, such as image, audio, video, or other multimedia content. For illustration, the content creator may be the host of a room for rent, and the uploaded content may be a rental listing; however, this example is not meant to limit the type of content that may be uploaded, or the means through which the server obtains the content.

The server in this example stores and makes the content available in the first language to users who wish to view it. To save processing resources, the server may not necessarily detect the language of the content at the time the content is initially uploaded. Rather, the server may wait until the content is requested for viewing (e.g., a user navigates to a web page corresponding to the content) at least a threshold of times before determining the language of the content and potentially triggering the translation process.

Each user in this example (e.g., potential guests looking to rent the room corresponding to the listing) preselects a language or a locale during a registration process, and the server associates the selected language, or the language corresponding to the selected locale, with the user (e.g., by setting a preferred language in a user profile). When a particular user satisfies the viewing threshold (e.g., a predetermined number of users have requested to view the content), the server compares the language of the content (e.g., Korean) to the preferred language of the particular user (e.g., English), and if the languages are determined to be different, the server triggers the translation process.

Continuing with this example, the translation process may involve the use of machine learning translation algorithms, with optional human-supervised training and/or oversight, to obtain high quality translations that are more accurate than generic machine translations. As such, in some implementations, the high quality translation of the content (e.g., the rental listing in English) may not be immediately available to the particular user who triggered the translation process. In such scenarios, the server may provide the particular user with the content in the original language while obtaining the high quality translation for subsequent users associated with the translated language who request to view the content. The server automatically provides subsequent users with the high quality translations, since at that point, the content has already been translated and cached at the server.

The translated content may be used to train the machine learning translation algorithm, thereby providing specialized training data sets having terminology that highly corresponds with other content at the server (e.g., terms commonly used in rental listings). Using specialized training data sets in this manner refines the machine learning translation algorithm in a way that causes the accuracy of subsequent translations to be increased over time. In addition, since content is not translated until the viewing threshold is met, content can benefit from machine learning translation refinements that happen after the content is obtained by the server and before the viewing threshold is met.

In some implementations, evaluation and rating of machine learning results by linguists may be used to further tune the machine learning translation algorithm (sometimes referred to as reinforcement learning). In addition, tone and voice guidelines may be used to further tune the machine learning translation algorithm. In addition, specialized glossaries may be used to further tune the machine learning translation algorithm.

By selectively triggering the translation process in the aforementioned manner, the translation system only translates content for scenarios in which interest in translations exceed a predetermined amount, which is more cost efficient than translating all content. Further, the predetermined amount (the viewing threshold) can be adjusted to reflect different cost structures for the translation service and/or different budgets for providing such translations. If the cost for providing translations becomes too high, the viewing threshold for triggering translations can be increased (e.g., from 2 views to 5 views). In addition, if the cost structure for a translation service involves increased costs for increased usage, the viewing threshold for triggering translations can be increased before the next cost tier is reached. By controlling the viewing threshold for triggering the translation process, companies can have greater control over translation budgets, compared to systems with pay-per-click policies.

By caching the translations, translation services need only be used once each time content is translated, rather than paying a third-party translation vendor each time a translation for the same content is requested. Further, processing latency or other types of delays associated with obtaining high quality translations need only affect users who view the content before the translation process is triggered, since once the high quality translations are cached, they may automatically be provided to subsequent users without delay.

The selective pre-translation process described herein allows customers to view content in whichever language they prefer, simply by performing a one-time language selection during registration. As such, once viewing thresholds are met, customers no longer need to view content in other languages or request translations by clicking “translate” buttons. Instead, customers automatically see content the way they want, which results in increased comprehension and satisfaction, which results in higher conversion rates (e.g., from viewing a rental listing to selecting a booking option).

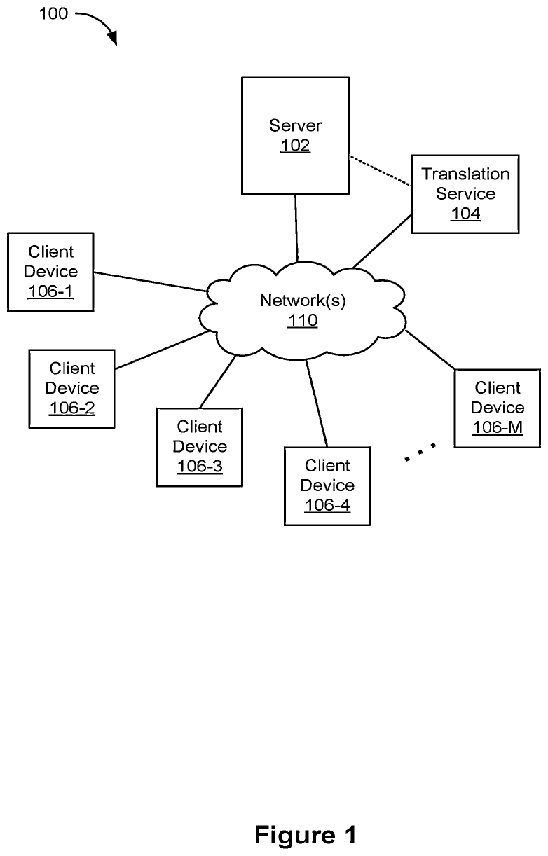

The following discussion, with reference to FIGS. 1-7, provides a more detailed description of various implementations of the selective pre-translation process illustrated in the example above.

FIG. 1 is a block diagram of an online content hosting environment 100 including a server 102 configured to selectively pre-translate content in accordance with some implementations. In addition to the server 102, environment 100 includes a translation service 104, a plurality of client devices 106, and one or more communication networks 110.

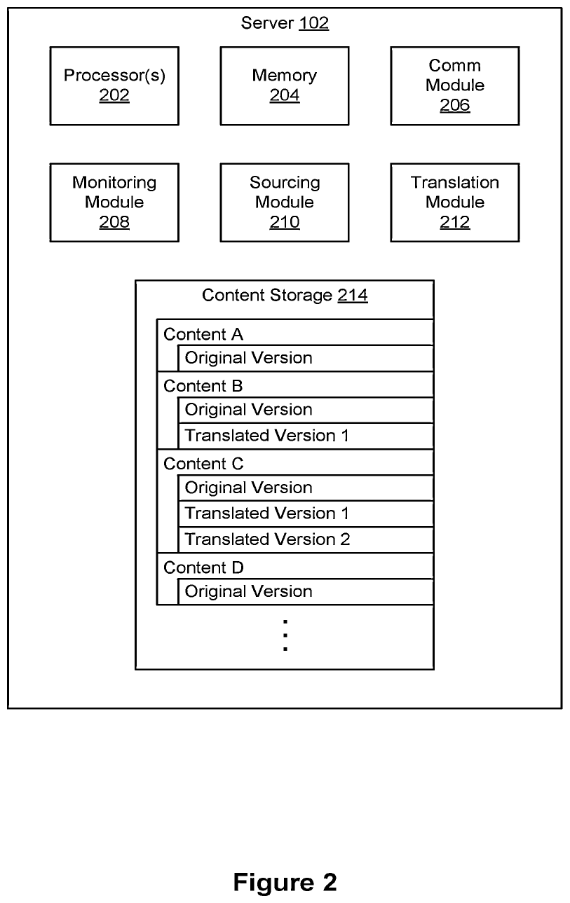

Server 102 is an electronic computing device or system configured to provide resources, data, services, or programs to other computing devices (e.g., 106) over a network (e.g., 110). Server 102 is configured to obtain content, monitor how many times the content is requested for viewing by the client devices, obtain translations via the translation service 104 upon viewing thresholds being met, store translated content, and provide the translated content to client devices that request to view it subsequent to the obtaining of respective translations, as described in more detail below with reference to FIGS. 2 and 5-7.

Translation service 104 is any combination of computing devices and/or processing modules integrated with the server 102 or in communication with the server 102 and configured to provide translated versions of content provided by the server 102. Server 102 and translation service 104 may communicate via communication network(s) 110 for scenarios in which translation service 104 is remote from server 102 (e.g., a third-party translation vendor), or may directly communicate for scenarios in which translation service 104 is integrated with server 102 (e.g., a machine learning translation module of the server).

Client devices 106 are personal electronic computing devices associated with respective users. Client devices 106 include, but are not limited to, smartphones, tablet computers, laptop computers, smart cards, voice assistant devices, or other technology (e.g., a hardware-software combination) known or yet to be discovered that has structure and/or capabilities similar to the mobile devices described herein. Each client device 106 includes a communication capability (e.g., modem, transceiver, radio, and so forth) for communicating through communication network(s) 110.

Communication network(s) 110 communicatively couple the server 102 and client devices 106 (and optionally the translation service 104) to each other. The communication network(s) 110 are configured to convey communications (messages, signals, transmissions, and so forth). The communications include various types of information and/or instructions including, but not limited to, data, commands, bits, symbols, voltages, currents, electromagnetic waves, magnetic fields or particles, optical fields or particles, and/or any combination thereof. The communication network(s) 110 use one or more communication protocols, such as any of Wi-Fi, Bluetooth, Bluetooth Low Energy (BLE), near-field communication (NFC), ultra-wideband (UWB), radio frequency identification (RFID), infrared wireless, induction wireless, ZigBee, Z-Wave, 6LoWPAN, Thread, 4G, 5G, and the like. Such protocols may be used to send and receive the communications using one or more transmitters, receivers, or transceivers. For example, hard-wired communications (e.g., wired serial communications) may use technology appropriate for hard-wired communications, short-range communications (e.g., Bluetooth) may use technology appropriate for close communications, and long-range communications (e.g., GSM, CDMA, Wi-Fi, wide area network (WAN), local area network (LAN), or the like) may use technology appropriate for remote communications over a distance (e.g., over the Internet). In general, the communication network(s) 110 may include or otherwise use any wired or wireless communication technology that is known or yet to be discovered.

FIG. 2 is a block diagram showing functional components of server 102, including modules configured to implement selective pre-translation of content in accordance with some implementations. Server 102 includes one or more processors 202, memory 204, communication module 206, monitoring module 208, sourcing module 210, translation module 212, and content storage 214. Although FIG. 2 shows various modules, FIG. 2 is intended more as a functional description of the various features which may be present in the modules than as a structural schematic of the implementations described herein. In practice, the programs, modules, and data structures shown separately could be combined, and some programs, modules, and data structures could be separated.

Processor(s) 202 include one or more central processing units (CPUs) or any other electronic circuitry configured to execute instructions comprising a computer program (e.g., the programs stored in the memory 204).

Memory 204 includes a non-transitory computer readable storage medium, such as volatile memory (e.g., one or more random access memory devices) and/or non-volatile memory (e.g., one or more flash memory devices, magnetic disk storage devices, optical disk storage devices, or other non-volatile solid state storage devices). The memory may include one or more storage devices remotely located from the processor(s). The memory stores programs (described herein as modules and corresponding to sets of instructions) that, when executed by the processor(s) 202, cause the server 102 to perform functions as described herein. The modules and data described herein need not be implemented as separate programs, procedures, modules, or data structures. Thus, various subsets of these modules and data may be combined or otherwise rearranged in various implementations.

Communication module 206 connects the server 102 to other devices (e.g., client devices 106) via one or more wired or wireless network interfaces and communication network(s) 110;

Monitoring module 208 is configured to monitor content in the content storage 214 and keep track of viewing thresholds (i.e., how many times a particular content item has been requested for viewing). When a particular content item is requested for viewing, monitoring module 208 determines whether that request satisfies a viewing threshold, and communicates a result of that determination (e.g., threshold met, or threshold not met) to sourcing module 210.

Sourcing module 210 is configured to determine a source of content to provide to client devices in response to requests to view the content. Upon receiving a viewing threshold determination from monitoring module 208, sourcing module 210 determines whether to trigger a translation process using translation module 212, and whether to provide the original version of the requested content or a translated version of the requested content, based on which versions are already cached in the content storage 214. Sourcing module 210 compares the original language of the content to the preferred language of the user associated with the client device requesting the content, and if the languages are different and if a translation of the content in the preferred language is not already cached in content storage 214, sourcing module 210 triggers the translation process using translation module 212. If the translation of the content in the preferred language is already cached in content storage 214, sourcing module 210 provides the translated version to the client device requesting to view the content. Upon triggering the translation process, sourcing module 210 may provide the original version of the content to the client device requesting the content if the translated content is not yet available. If the original language and the preferred language of the user associated with the client device requesting the content are the same, then sourcing module 210 provides the original version of the content to the client device requesting to view the content.

Translation module 212 obtains translations of content (indicated by sourcing module 210) via translation service 104. For implementations in which translation service 104 is integrated with server 102 (e.g., a machine-learning translation algorithm stored in memory 204, translation module 212 provides the original version of the content to the translation service 104 and/or obtains the translated version of the content when it is ready. For implementations in which translation service 104 is remote from server 102 (e.g., a third-party translation vendor), translation module 212 provides the original version of the requested content to, and receives the translated version of the requested content from, the translation service 104 via the communication module 206 and communication network(s) 110. Regardless of the translation service 104 implementation, upon receiving the translated version of the requested content, translation module 212 stores the translated version of the requested content in the content storage 214, associating the translated version with the original version so that sourcing module 210 can access the translated version of the content in accordance with subsequent requests to view the content in the translated language.

Content storage 214 includes content obtained by the server 102. Content storage 214 may be part of memory 204, or may be stored in a separate data storage (e.g., database) that is part of the server 102 or separate from (but in communication with) the server 102. The content may be any content stored at the server 102 for provision to a client device upon receiving a request to view it. One example of such content is room rental listings, obtained from client devices 106 associated with users acting in a rental hosting capacity. Another example of such content is customer support documentation provided by employees of the company associated with the server 102. These examples are provided for illustrative purposes and are not meant to be limiting. When server 102 obtains an item of content, monitoring module 208 stores the original version of the content (the version of the content in the original language) in the content storage 214. When translation module 212 obtains a translated version of the content (from translation service 104), translation module 212 stores the translated version of the content with the original version of the content in the content storage 214.

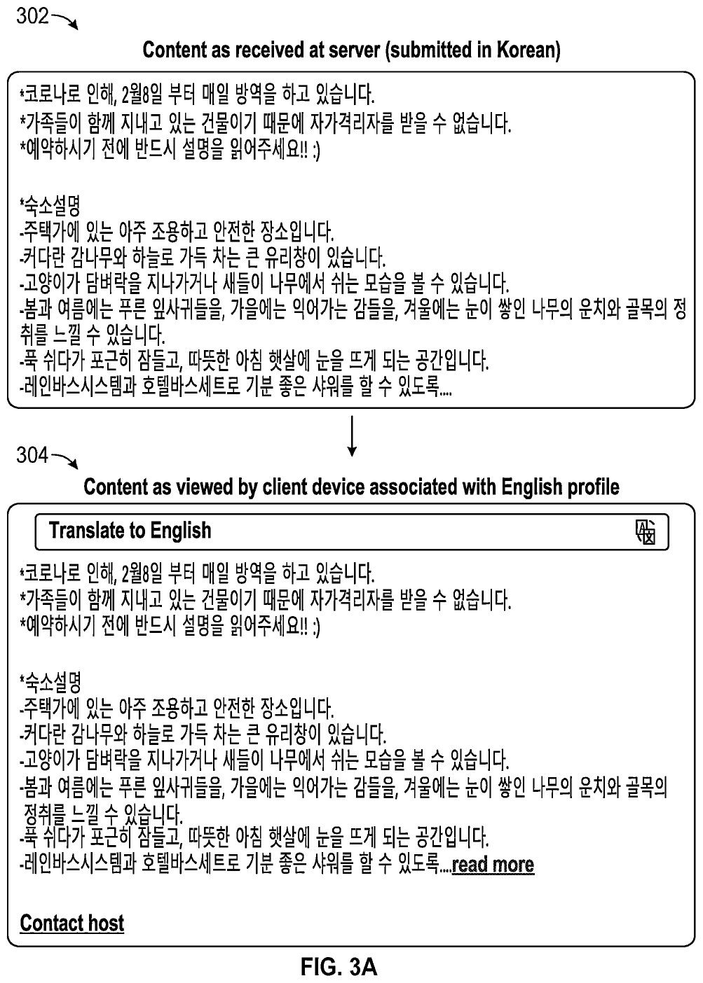

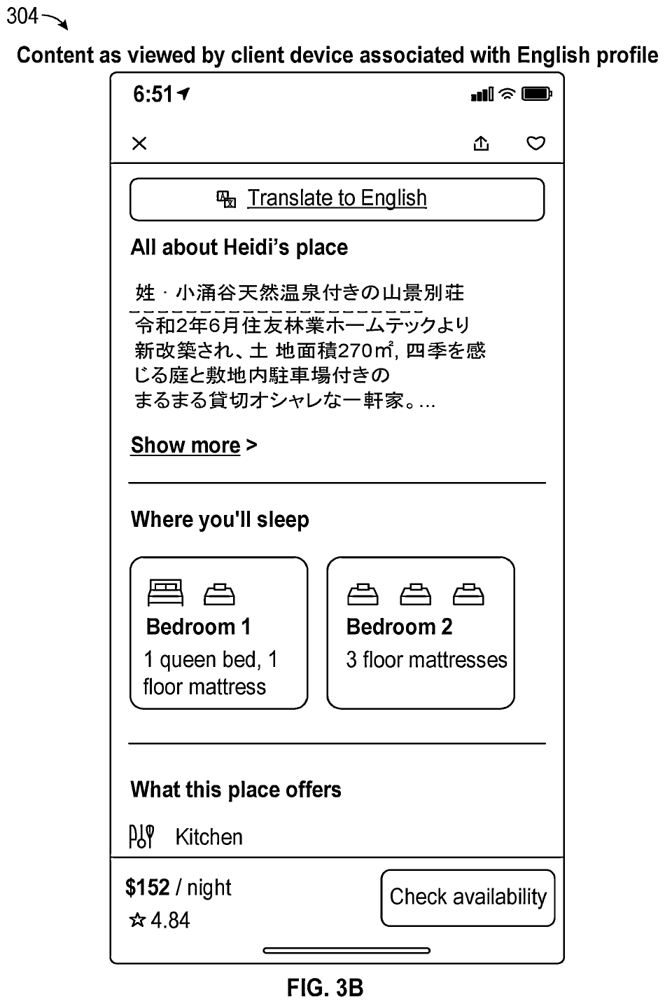

FIG. 3A depicts an original version 302 of content obtained by server 102 in a first language (e.g., Korean), and a version 304 of the content as provided to and viewed by a client device 106 associated with a second language (e.g., English), where the requested content has not yet been pre-translated at the server 102. FIG. 3B depicts another example of version 304 of the content provided to and viewed by the client device 106 associated with the second language (e.g., English). When server 102 obtains the original version 302 of the content, server 102 stores the content and makes the content available to client devices that send requests to view the content. In some implementations, if a client device 106 requests to view the content, but the request does not satisfy a viewing threshold (e.g., if the threshold is 2, but the request is the first request to view the content), then the server 102 may provide version 304 of the content in its original language to the client device 106. In another example, if the request does satisfy the viewing threshold (e.g., if the threshold is 2, and the request is the second request to view the content), then the server 102 may still provide version 304 of the content in its original language to the client device 106 while triggering a translation process as described herein (e.g., operations 612-616, 718 below). In these preceding “viewing threshold” examples, version 304 of the content in the original language may optionally include a “translate” option (e.g., a “Translate to English” selectable user interface element for display at the client device) for the user of the client device to select in order to view the content in a language different from the original language.

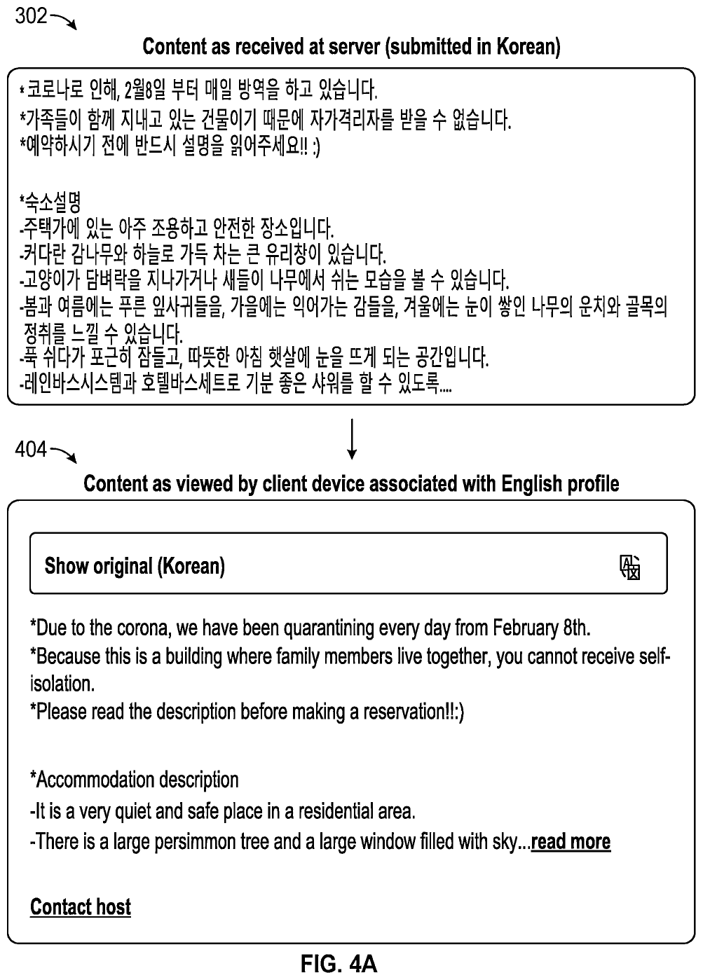

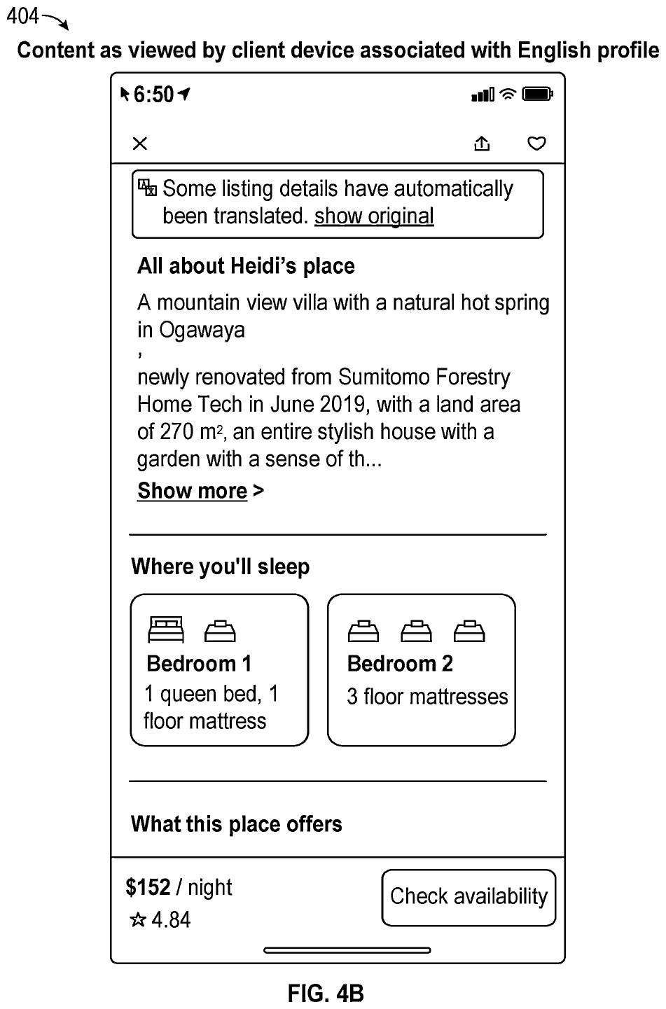

FIG. 4A depicts an original version 302 of content obtained by server 102 in a first language (e.g., Korean), and a version 404 of the content as provided to and viewed by a client device 106 associated with a second language (e.g., English), where the requested content is translated or has already been translated and cached at the server 102 in conjunction with translation service 104. FIG. 4B depicts another example of version 404 of the content provided to and viewed by the client device 106 associated with the second language (e.g., English), where the requested content is translated or has already been translated and cached at the server 102 in conjunction with translation service 104. When server 102 obtains the original version 302 of the content, server 102 stores the content and makes the content available to client devices that send requests to view the content. If a client device 106, associated with a second language, requests to view the content, the server 102 may implement the translation process (e.g., operations 612-616, 718 below), and may automatically provide version 404 of the content in the second language to the client device 106. In a further example, if a client device 106, associated with a second language, requests to view the content, and the content is already stored at the server 102 in the second language as a result of the translation process (e.g., operations 612-616, 718 below) having previously been triggered, the server 102 may automatically provide version 404 of the content in the second language to the client device 106. Version 404 of the content in the second language may optionally include a “show original” option (e.g., a “Show original (Korean)” selectable user interface element for display at the client device) for the user of the client device to select in order to view the content in the original language.

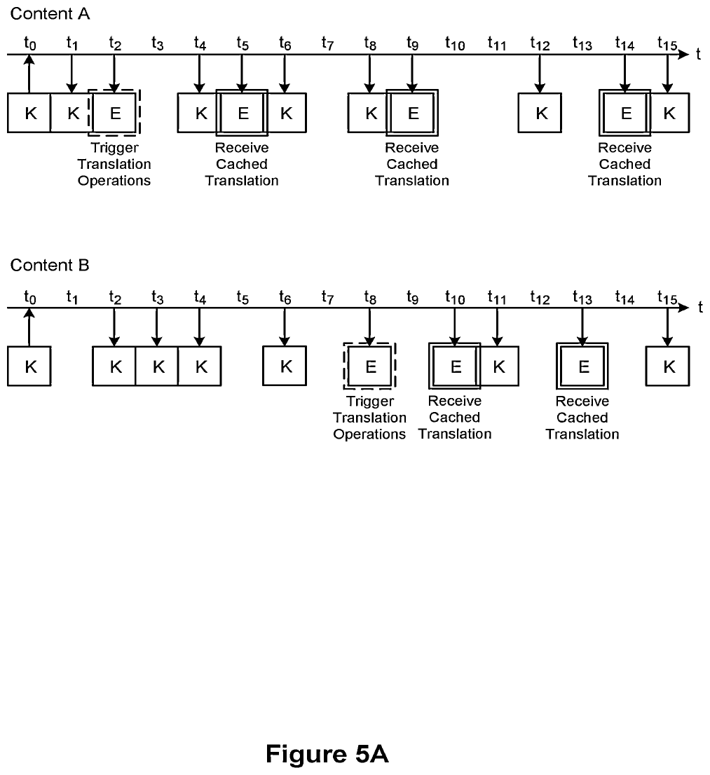

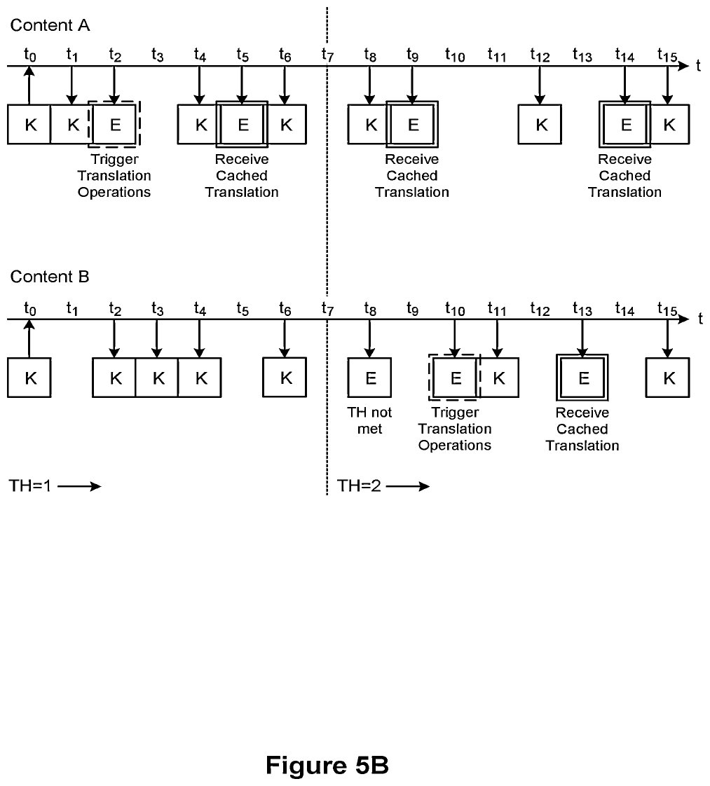

FIGS. 5A-5B are timing diagrams of example operating scenarios of the online content hosting environment 100 in accordance with some implementations. The horizontal axes represent time, and each block represents a different client device 106. Each client device either uploads content (represented by an arrow pointing up) or downloads content (represented by an arrow pointing down) from server 102. The K blocks represent client devices associated with a first language (e.g., Korean) as the preferred language, and the E blocks represent client devices associated with a second language (e.g., English) as the preferred language. While the Korean and English languages are used in this example for illustrative purposes, the concepts described herein apply to any other language.

FIG. 5A depicts timing diagrams corresponding to two content items—Content A and Content B. In one example, Content A and B may be rental listings describing different spaces for rent. In another example, Content A and B may be posts in a customer support forum. At time to, two client devices upload a respective content item in Korean, and server 102 receives the content and stores it in content storage 214.

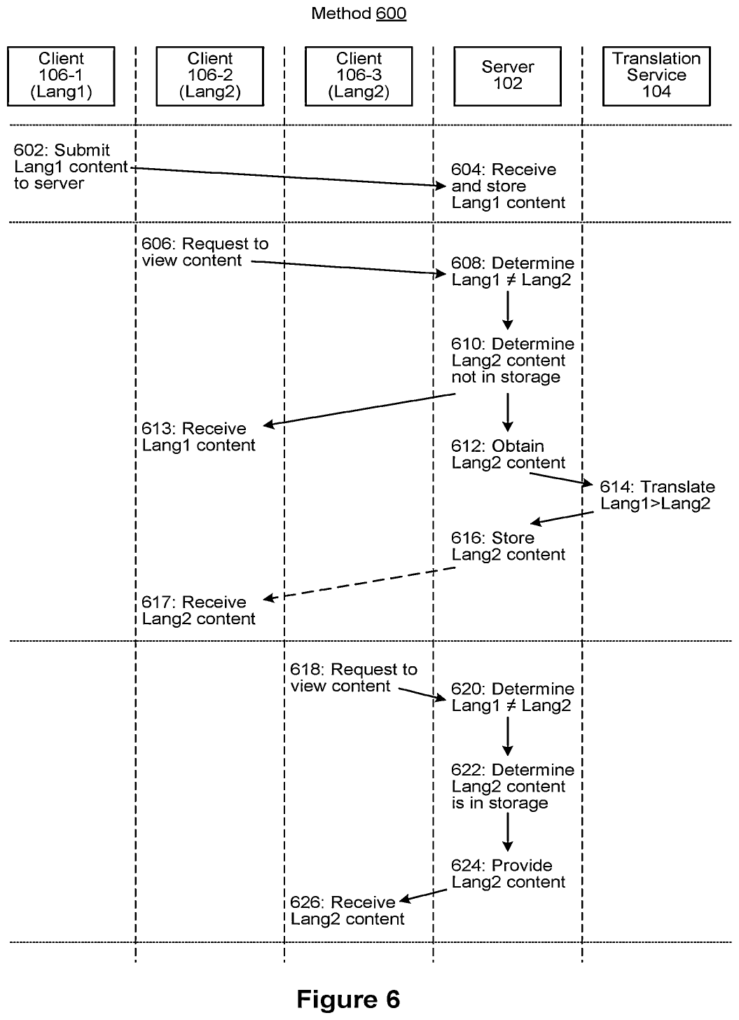

In response to requests from a plurality of K devices (client devices or users of client devices associated with the preferred language of Korean) to view Content A, server 102 provides Content A, in the original language of Korean, to the plurality of K devices at times t1, t4, to, and so forth. At time t2, an E device (a client device or user of a client device associated with the preferred language ofhd English) requests to view Content A, which triggers translation operations (e.g., 608-616 described below with reference to FIG. 6). The translation operations cause the server 102 to obtain an English translation of Content A from translation service 104 and store the translation in a cache (content storage 214). As a result, subsequent E devices that request to view Content A (at times t₅, t₉, and t₁₄) automatically receive the cached English translation of Content A, as described in more detail below with reference to operations 618-626 in FIG. 6.

In response to requests from a plurality of K devices to view Content B, server 102 provides Content B, in the original language of Korean, to the plurality of K devices at times t₂, t₃, t₄, and so forth. At time t₈, an E device requests to view Content B, which triggers translation operations (e.g., 608-616 described below with reference to FIG. 6). The translation operations cause the server 102 to obtain an English translation of Content B from translation service 104 and store the translation in the cache (content storage 214). As a result, subsequent E devices that request to view Content B (at times t₁₀ and t₁₃) automatically receive the cached English translation of Content B, as described in more detail below with reference to operations 618-626 in FIG. 6.

As shown in this scenario, two content items may be uploaded in one language at the same time (or within the same range of time), yet the server-based translations of each content item may be triggered at different times depending on when each content item is viewed by a client device associated with a different language. Specifically, two content items uploaded at time to may be translated at different times (at times t₂ and t₈) based on when each content item is viewed by a client device associated with a different language.

In addition, the translation of one of the content items does not trigger translations of other content items. Specifically, the server-based translation of Content A at time t2 does not trigger the translation of Content B. Rather, the server does not obtain a translation of Content B until a client device associated with another language views the content at time t₈.

FIG. 5B depicts the timing diagrams as shown in FIG. 5A, with the addition of a change in the viewing threshold TH required for translation operations to be triggered at the server 102. In this example, the viewing threshold TH for triggering the obtaining of a translation from translation service 104 is equal to 1 at time t₀, and changes to 2 at time t₇ (e.g., in order to decrease costs associated with the use of translation service 104). As such, before time t₇, the first client device associated with English or the first request to view the content in English will cause the server 102 to trigger translation operations (e.g., 608-616 described below with reference to FIG. 6). After time t₇ (when the viewing threshold changes to 2), the first client device associated with English or the first request to view the content in English no longer triggers the translation operations; rather, the second client device associated with English or the second request to view the content in English triggers the translation operations.

As such, the timing of translation operations for Content A remains the same as described above with reference to FIG. 5A, since the first request by an E device to view Content A (at time t₂) is received at the server 102 while the viewing threshold TH=1. However, with the viewing threshold TH set to 2 at time t₇, the request by the E device at time ts to view Content B does not trigger translation operations, since the viewing threshold TH has been changed to 2 and there have not yet been two E devices that have requested to view Content B. Since the viewing threshold TH=2, and the E device at time ts is only the first E device to request to view content B, the viewing threshold TH is not met, and the server 102 provides the content in the original language of Korean to the E device at time t₈. At time t₁₀, a second E device requests to view Content B. Since the viewing threshold TH=2, and this is the second E device to request to view Content B, the viewing threshold TH is met, which triggers translation operations (e.g., 608-616 described below with reference to FIG. 6). The translation operations cause the server 102 to obtain an English translation of Content B from translation service 104 and store the translation in the cache (content storage 214). As a result, subsequent E devices that request to view Content B (e.g., at time t₁₃) automatically receive the cached English translation of Content B, as described in more detail below with reference to operations 618-626 in FIG. 6.

As shown in this scenario, increasing the viewing threshold TH causes translation operations to be delayed. Specifically, in FIG. 5A (with TH=1 at time t₈), the viewing request at time t₈ caused the server 102 to obtain a translation of Content B. However, in FIG. 5B (with TH=2 at time t₈), the server 102 did not obtain a translation of Content B until time t₁₀. On a macro level, with hundreds, thousands, or tens of thousands (or more) of content items being uploaded and viewed every hour or every day, slowing down translation operations by adjusting the viewing threshold TH (as shown in this example) can contribute to significant cost savings. This adjustment may affect the user experience of a handful of users for each content item (e.g., the first X users to view an item, where X is less than the viewing threshold TH). But content items that only viewed by X or fewer users may have less of a business need to be translated, while content items that are viewed by more than X users may be popular enough to warrant server-based translation operations, thereby providing a positive user experience to viewers of more popular content items. As such, server-based translation operations need not be turned on or off globally; rather, translation operations can be selectively applied based on where they are needed the most, thereby optimizing the trade-off between user experience and cost.

FIG. 6 is a flow diagram depicting a method 600 of operating the online content hosting environment 100 (including three client devices 106-1, 106-2, 106-3, the server 102, and translation service 104) in accordance with some implementations. The process may be governed by instructions that are stored in a computer memory or non-transitory computer readable storage medium of each component of environment 100 (e.g., processor(s) 202 for the server 102). The instructions for each component of environment 100 may be included in one or more programs stored in the non-transitory computer readable storage medium. When executed by one or more processors (e.g., processor(s) 202 for server 102), the instructions cause the various components of the environment 100 to perform the operations. The non-transitory computer readable storage medium for each component may include one or more solid state storage devices (e.g., Flash memory), magnetic or optical disk storage devices, or other non-volatile memory devices. The instructions for each component may include source code, assembly language code, object code, or any other instruction format that can be interpreted by one or more processors. Some operations in the process may be combined, and the order of some operations may be changed. Further, some components of environment 100 may perform operations depicted as being performed by other components (e.g., the server 102 may perform operation 614).

Referring to method 600, a client device 106-1 submits (602) content in a first language (Lang1) to the server 102. For the room rental listing example, this user may be a rental host, and the content may be a rental listing (e.g., 302, FIG. 3A). In another example, this user may be a customer support technician, and the content may be a frequently asked questions post. Regardless of the identity of the user or the substance of the content, the server 102 receives (604) the content and stores it locally (e.g., Content B, Original Version in content storage 214, FIG. 2).

In some implementations, prior to submitting the content to the server 102, client device 106-1 may be associated with the first language during a registration process. In one example, a user of client device 106-1 creates a profile and selects a preferred language or selects a locale (a location of the user). For example, the user may select Korcan as a preferred language, or the user may select Seoul or South Korea (either of which can correspond to Korean based on preset correspondences between locales and languages at the server 102) as the user's locale. The selected language, or the language corresponding to the selected locale, may be associated with the user's profile (or assigned to the user or the user's client device in any other way), and the profile may be stored locally at the client device 106-1 and/or at the server 102. As such, the server 102 may subsequently determine the language of the submitted content by referencing the selected language, or the language corresponding to the selected locale, in the profile associated with the user of client device 106-1.

Before the server 102 provides the content to a predetermined threshold of other client devices, client device 106-2 submits a request (606) to the server 102 to view the content, wherein the request is associated with a second language (Lang2) selected by a user operating client device 106-2. Specifically, at some point prior to requesting to view the content, client device 106-2 may be associated with the second language during a registration process. In one example, a user of client device 106-2 creates a profile and selects a preferred language or selects a locale (a location of the user). For example, the user may select English as a preferred language, or the user may select San Francisco or United States (either of which can correspond to English based on preset correspondences between locales and languages at the server 102) as the user's locale. The selected language, or the language corresponding to the selected locale, may be associated with the user's profile (or assigned to the user or the user's client device in any other way), and the profile may be stored locally at the client device 106-2 and/or at the server 102. As such, the server 102 may subsequently determine the preferred language of the user of client device 106-2 by referencing the selected language, or the language corresponding to the selected locale, in the profile associated with the user of client device 106-2.

In some implementations, if a user is not logged in to a profile specifying a preferred language, or in any other scenario in which a user is not already associated with a preferred language, the user may be associated with the default language for the subdomain or top-level domain (TLD) based on the Internet Protocol (IP) location of the user's client device 106. For example, a logged out user in France will get France French by default and trigger French machine translation events accordingly.

In response to receiving the request, the server 102 determines (608) that the first language (e.g., Korean) of the content as submitted by client device 106-1 is different from the second language (e.g., English) associated with client device 106-2 (or otherwise associated with the request received from client device 106-2). In one example, this determination may be made by comparing the languages associated with each client device, or the languages associated with the user of each client device (e.g., the user profile as discussed above). In another example, this determination may be made by comparing the locales of each client device (including comparing the languages corresponding to each locale). Referring to the request received from client device 106-2 is an Nth request to view the content (N being an integer greater than or equal to 1), the server 102 may perform translation operations 608-616 in accordance with a determination that N is greater than or equal to a predetermined viewing threshold. The predetermined viewing threshold may be as low as 1, meaning that the first request to view the content submitted by client device 106-1 will trigger translation operations 608-616. The predetermined viewing threshold may be greater than one. For example, if the threshold is 2, then the first request to view the content submitted by client device 106-1 will not trigger translation operations 608-616, but the second request will trigger translation operations 608-616. As discussed above, the server 102 may adjust the predetermined viewing threshold based on a cost associated with obtaining the translated version of the content in the second language from translation service 104.

In some implementations, upon determining that the first language of the content as submitted by client device 106-1 is different from the second language associated with client device 106-2 (or otherwise associated with the request received from client device 106-2), the server 102 determines whether a storage (e.g., 214) of the server 102 already includes a translated version of the content in the second language (Lang2 content). In accordance with a determination (610) that the server 102 does not already have a translated version of the content in the second language, the server 102 proceeds by obtaining (612) a translated version of the content in the second language from translation service 104.

In response to a request by the server 102 to obtain the translated content, translation service 104 translates (614) the content from the first language to the second language. Translation service 614 may use a machine-translation algorithm based on one or more machine learning processes that are trained using content previously received at the server 102 and translated by translation service 104. As such, the resulting translations are more accurate (and thus, higher quality) since the training data sets use similar terminology. For example, if the content comprises room rental listings, the algorithm used by translation service 104 may be trained using previously submitted room rental listings and corresponding translations considered to be accurate by supervised or unsupervised machine learning.

Specifically, machine learning comprises the task of learning a function that maps an input to an output based on example input-output pairs. It infers a function from labeled training data consisting of a set of training examples. Here, the training examples may include original and translated versions of content already translated and stored in the content storage 214 at the server 102. Each example is a pair consisting of an input object (typically a vector) and a desired output value (also called the signal). Here, the input objects may be sentence fragments, full sentences, or other syntax elements related to a given language, and the output values may be translated versions of the sentence fragments, full sentences, or other syntax elements related to a language other than the given language.

In some implementations, it may not be desirable to cause the user of client device 106-2 to wait for operations 612 and 614 to complete. In such scenarios, the server 102 may provide (613) the content in the first language to client device 106-2 rather than making the user wait for translation service 104 to complete the translation. The version of the content in the first language provided to client device 106-2 in operation 613 may include an option to translate the content to the preferred language associated with the user of the client device 106-2 (e.g., the “Translate to English” option in version 304 of the content, FIGS. 3A-3B). In response to the server 102 receiving an indication from client device 106-2 that the user selected such an option, the server 102 may obtain a non-cached (not stored in content storage 214) version of the content in the second language from a different translation service optimized for efficiency (with the translation accuracy not necessarily being as high as that associated with translation service 104). An example of such a translation service may be a generic machine-translation service such as Google Translate, while an example of translation service 104 may be a higher quality (higher accuracy) translation service using supervised or unsupervised learning with targeted training data sets as described above. The server 102 may provide the lower quality machine translation to the user, or alternatively, a translation service may provide the lower quality machine translation directly to the user (e.g., through a feature of the user's browser). That away, the user may quickly receive a quick translation without having to wait for the server 102 and translation service 104 to obtain a higher quality translation via operations 612-616.

In an alternative implementation of operation 613, rather than providing the content in the first language with an option to translate the content to the second language to client device 106-2 (e.g., a version of 304, FIGS. 3A-3B), the server 102 may provide (613) the content in the second language using the non-cached (not stored in content storage 214) version of the content in the second language from the different translation service (e.g., a version of 404, FIGS. 4A-4B).

Upon receiving the translated version of the content in the second language from translation service 104, the server 102 stores (616) the translated version of the content in the second language (e.g., Content B, Translated Version 1) in content storage 214. This stored translation may then be provided to users who subsequently request to view the content in the second language, as described below with reference to operations 618-626. In some implementations, this stored translation may optionally be provided (617) to client device 106-2.

Regardless of which version of the translated content in the second language the server 102 provides to client device 106-2 (a lower quality translation in operation 613 or a higher quality translation in operation 617), the server 102 may additionally provide, or cause to be displayed, an original-language option to client device 106-2 (e.g., the “Show original (Korean)” user interface element in version 404 of the content, FIGS. 4A-4B). Upon receiving an indication from client device 106-2 that the original-language option was selected, the server 102 provides the content in the first language (e.g., 304, FIGS. 3A-3B) to client device 106-2.

To be clear, while the stored translation of the content in the second language may be provided to one or more client devices associated with subsequent requests to view the content in the second language (e.g., as described with reference to operations 618-626 below), the stored translation of the content in the second language may not necessarily be provided to the client device associated with the visit that triggered translation operations 608-616 (here, client device 106-2). Instead, in some implementations, the client device associated with the visit that triggered translation operations 608-616 (client device 106-2) may not be provided with the high quality translation obtained as a result of those operations. However, by not pre-translating content for client devices associated with initial requests to view content (e.g., client device 106-2 and operation 606), the server 102 provides for more efficient and cost-effective use of machine-learning translation processes. Such processes are likely to be less burdened by only selectively translating content when viewing thresholds are met, as described herein.

Once a translated version of the content in a second language has been obtained and stored at the server 102, server 102 may respond to subsequent requests to view the content in the second language by automatically providing the translated version stored at the server 102. Operations 618-626 are an example of this feature.

Another client device 106-3 submits a request (618) to the server 102 to view the content, wherein the request is associated with the second language (Lang2) selected by a user operating client device 106-3 (the same language selected by the user operating client device 106-2). Specifically, at some point prior to requesting to view the content, client device 106-3 may be associated with the second language during a registration process. In one example, a user of client device 106-3 creates a profile and selects a preferred language or selects a locale (a location of the user). For example, the user may select English as a preferred language, or the user may select San Francisco or United States (either of which can correspond to English based on preset correspondences between locales and languages at server 102) as the user's locale. The selected language, or the language corresponding to the selected locale, may be associated with the user's profile (or assigned to the user or the user's client device in any other way), and the profile may be stored locally at the client device 106-3 and/or at the server 102. As such, the server 102 may subsequently determine the preferred language of the user of client device 106-3 by referencing the selected language, or the language corresponding to the selected locale, in the profile associated with the user of client device 106-3.

In response to receiving the request (and, in some implementations, in response to the viewing threshold being satisfied as discussed above), the server 102 determines (620) that the first language (e.g., Korean) of the content as submitted by client device 106-1 is different from the second language (e.g., English) associated with client device 106-3 (or otherwise associated with the request received from client device 106-3). The server 102 also determines (622) that the storage of the server (content storage 214) includes the translated version of the content in the second language. In accordance with these determinations, the server 102 provides (624) the translated version of the content in the second language to client device 106-3. Thus, client device 106-3 automatically receives the high quality translation in the second language upon visiting the webpage hosting the content, without requiring a user to select an option to translate the content into the second language.

In some implementations, subsequent to receiving the request to view the content from client device 106-2 (operation 606) (the request that causes the viewing threshold to be satisfied), the server 102 may receive an update to the content from client device 106-1 in the first language (an update from the original author of the content). Since server 102 has already identified this content as worthy of pre-translation (due to the viewing threshold being met), the server 102 may automatically obtain a translation of the updated portion of the content from translation service 104 in the second language, without requiring additional views or requests for views from other client devices. The server 102 may store the translated version of the update to the content in the second language in the storage of the server (e.g., in content storage 214, as an update to Translated Version 1 of Content B). Obtaining a translation of only the updated portion of the content, rather than resubmitting the entire content item for translation, provides for additional processing optimization and cost reduction since content that is already translated does not need to be translated again.

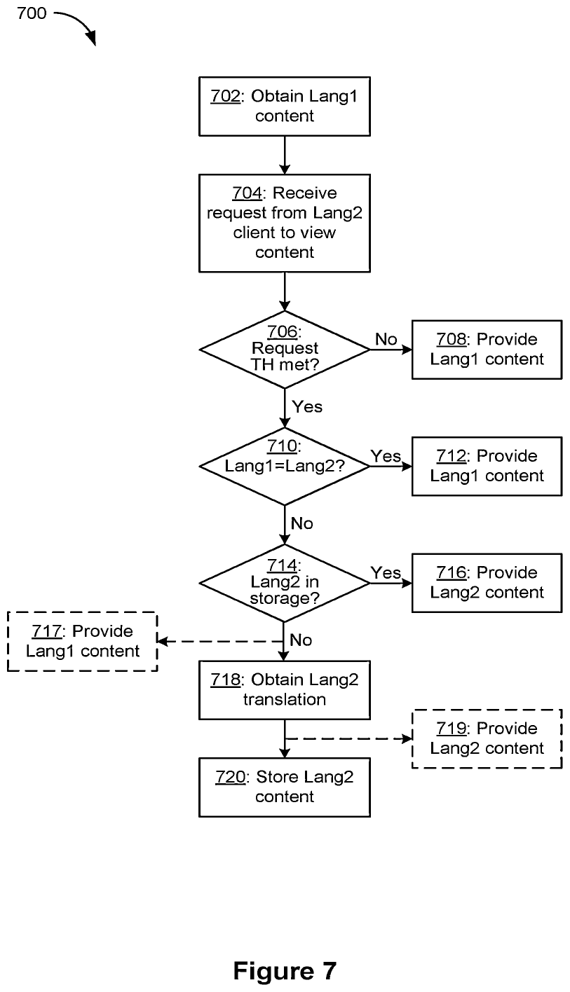

FIG. 7 is a flow diagram depicting a process 700 of pre-translating content at the server 102 in accordance with some implementations. Process 700 corresponds to the operations 600 of the server 102 in FIG. 6. Process 700 may be governed by instructions that are stored in a computer memory or non-transitory computer readable storage medium of the server 102 (e.g., memory 204). The instructions may be included in one or more programs stored in the non-transitory computer readable storage medium. When executed by one or more processors of the server 102 (e.g., processor(s) 202), the instructions cause the server 102 to perform the process. The non-transitory computer readable storage medium may include one or more solid state storage devices (e.g., Flash memory), magnetic or optical disk storage devices, or other non-volatile memory devices. The instructions may include source code, assembly language code, object code, or any other instruction format that can be interpreted by one or more processors. Some operations in the process may be combined, and the order of some operations may be changed.

The server 102 obtains (702) content in a first language (Lang1) from a client device (e.g., 106-1) having been associated with a first language (Lang1) via a registration process (including a language or locale selection as described above). The server stores the content in the first language and makes the content available for viewing upon request from other client devices 106, as described above with reference to operations 602-604.

The server 102 receives (704) a request from a first client device (e.g., 106-2) to view the content, where the request is associated with a second language (Lang2) as described above with reference to operation 606. For example, the client device corresponding to the request may have been associated with the second language during the registration process, and a user profile resulting from the registration process (stored at the server or at the client device) may reflect the selection of the second language as the preferred language of the user of the client device for viewing content.

The server 102 determines (706) whether a threshold of viewing requests (Request TH) (also referred to herein as a viewing threshold) has been met. For example, if the threshold is 1, then such a threshold will be met as soon as any client device requests to view the content. However, if the threshold is greater than 1 (e.g., 2), then the threshold may not be met for the first one or more client devices requesting to view the content.

If the threshold is not met, the server 102 provides (708) the content to the client device in the first language (the language in which the content was originally obtained by the server in operation 702). The content may include an option for a user to obtain a translation (e.g., a “Translate to English” user interface element as depicted in version 304 of the content in FIGS. 3A-3B).

If the threshold is met, the server 102 determines (710) whether the first language (corresponding to the content as originally obtained) matches the second language (corresponding to the preferred language of the user of the client device requesting to view the content), as described above with reference to operation 608. As part of this determination, the server may consult the language preference in the profile corresponding to the user of the client device requesting to view the content. The server may additionally or alternatively consult the locales corresponding to the client device from which the content was obtained and the client device from which the request was received for viewing the content.

If the two languages match, then the server 102 provides (712) the content to the client device in the first language (the language in which the content was originally obtained by the server in operation 702). The content may include an option for a user to obtain a translation (e.g., a “Translate to English” user interface element as depicted in version 304 of the content in FIGS. 3A-3B).

If the two languages do not match, then the server 102 determines (714) whether a version of the content in the second language is already available in storage of the server (e.g., content storage 214), as described above with reference to operation 610.

If a version of the content in the second language is already stored at the server, then the server provides (716) the version of the content in the second language to the client device requesting to view the content.

If a version of the content in the second language is not stored at the server 102 at this time, then the server 102 obtains (718) a version of the content in the second language (obtains a translation) from a translation service (e.g., 104), as described above with reference to operations 612 and 614

While the server 102 is obtaining the translation in operation 718, the server 102 may provide (717) the client device requesting to view the content with a version of the content that is already available at the server, such as the content in the first language (the language in which the content was initially obtained in operation 702), as described above with reference to operation 613.

Upon obtaining the translation of the content in the second language, the server 102 stores (720) the translation and makes the translation available for subsequent requests to view the content, where such requests are associated with the second language, as described above with reference 616. As such, the next time a request to view the content is received at the server 102 in operation 704, the server 102 automatically provides the translated version of the content in the second language in operation 716.

Optionally, the server 102 may provide (719) the translated version of the content in the second language obtained in operation 718 to the client device requesting to view the content, as described above with reference to operation 617.

In some implementations, the operations described above with reference to methods 600 and 700 may be supplemented with additional operations. The following discussion covers examples of some additional operations, which may optionally be included in the methods described above.

In some implementations, if the server 102 determines that the first language (of the content as obtained) and the second language (associated with a request to view the content) do not match at least a threshold of times, the server 102 may send a notification to the client device from which the content was initially obtained (e.g., 106-1) informing the content author that it may be worthwhile to upload the content in the second language. Such a scenario allows the content author to have an opportunity to provide an original translation for content that has already proven to be popular with users who speak a different language. A multilingual content author or a content author who has access to a preferred translation provider may take advantage of such a scenario and upload a version of the content in the second language.

In some implementations, if the language of the uploaded content does not match the language corresponding to the content author's country or other locale, the server 102 may send a notification to the client device of the content author (e.g., 106-1) informing the content author that the language of the uploaded content does not match the country of the content author. For example, if a host uploads a rental listing in Italy, and the listing is written in Korean, the server 102 may inform the host of the language mismatch, thereby providing the host with an opportunity to resubmit the content in the language corresponding to the local, which may result in increased business for the host.

In some implementations, if the language of the uploaded content matches the language of the content author's country or other locale, but does not match the language that the content author had selected during the registration process, the server may send a notification to the client device of the content author (e.g., 106-1) informing the content author that there is an option to upload the content in the language preferred by the content author, and that the server will provide a translation instead. In such a scenario, the host of a rental listing may upload content in a preferred language even if that language is not the one likely to be preferred by the target audience for the rental listing. If the host uploads the content in the host's native language, then the translation provided by the server may be more accurate than the translation provided by the host, especially if the host is not fluent in the second language.

In some implementations, the translations obtained by the server may include translated emoji attributes (e.g., genders, skin colors, and so forth), based on the attributes of users requesting to view the content (which may be selected by such users during the registration process).

The following are example implementations.

Example 1: A method of selectively pre-translating content at a server including one or more processors and memory, the method comprising: obtaining content in a first language; before providing the content to a first client device, receiving a first request from the first client device to view the content, wherein the first request is associated with a second language selected by a user operating the first client device; in response to receiving the first request, determining that the first language of the content is different from the second language associated with the first request; and in accordance with the determination that the first language of the content is different from the second language associated with the first request: obtaining a machine-translated version of the content in the second language; and providing the machine-translated version of the content in the second language to one or more client devices.

Example 2: The method of example 1, further comprising: storing the machine-translated version of the content in the second language in a storage of the server; receiving a second request from a second client device to view the content, wherein the second request is associated with the second language; in response to receiving the second request: determining that the first language of the content is different from the second language associated with the second request; and determining that the storage of the server includes the machine-translated version of the content in the second language; and in accordance with the determination that the first language of the content is different from the second language associated with the second request and the determination that the storage of the server includes the machine-translated version of the content in the second language: providing the machine-translated version of the content in the second language to the second client device.

Example 3: The method of any of examples 1-2, wherein the first request is an Nth request to view the content, and the method further comprises: in response to receiving the first request, determining that N is greater than or equal to a predetermined threshold for obtaining a machine translation, wherein the predetermined threshold is at least two; and obtaining the machine-translated version of the content in the second language is further in accordance with the determination that N is greater than or equal to the predetermined threshold.

Example 4: The method of any of examples 1-3, further comprising: adjusting the predetermined threshold based on a cost associated with obtaining the machine-translated version of the content in the second language.

Example 5: The method of any of examples 1-4, wherein the machine-translated version of the content in the second language is obtained from a machine-translation algorithm based on one or more machine learning processes that are trained using content received at the server.

Example 6: The method of any of examples 1-5, wherein obtaining the content in the first language includes obtaining user-submitted content from a third client device; and the method further comprises determining that the user-submitted content is in the first language based on an association of the first language with the third client device.

Example 7: The method of any of examples 1-6, further comprising: in response to receiving the first request, determining that the storage of the server does not include a machine-translated version of the content in the second language; wherein obtaining the machine-translated version of the content in the second language is further in accordance with the determination that the storage of the server does not include a machine-translated version of the content in the second language.

Example 8: The method of any of examples 1-7, further comprising: prior to receiving the first request from the first client device: receiving, from the first client device, selection of the second language as the selected language for the first client device; and assigning the second language to a profile associated with the user operating the first client device based on the selection of the second language; wherein the association of the first request and the second language is based on the second language being assigned to the profile associated with the user operating the first client device.

Example 9: The method of any of examples 1-8, further comprising: prior to receiving the first request from the first client device: receiving, from the first client device, selection of a locale of the first client device; and assigning the second language to a profile associated with the user operating the first client device based on the selection of the locale of the first client device; wherein the association of the first request and the second language is based on the second language being assigned to the profile associated with the user operating the first client device.

Example 10: The method of any of examples 1-9, further comprising: subsequent to receiving the first request, obtaining an update to the content in the first language; and in response to obtaining the update to the content in the first language and prior to receiving any subsequent requests to view the content: obtaining a machine-translated version of the update to the content in the second language; and storing the machine-translated version of the update to the content in the second language in the storage of the server.

Example 11: The method of any of examples 1-10, further comprising: in response to receiving the first request, providing the content in the first language to the first client device.

Example 12: The method of any of examples 1-11, wherein providing the content in the first language to the first client device includes providing a machine-translation option to the first client device; and the method further comprises: receiving an indication from the first client device that the machine-translation option was selected; in response to receiving the indication, obtaining a non-cached machine-translated version of the content in the second language; and providing the non-cached machine-translated version of the content in the second language to the first client device.

Example 13: The method of any of examples 1-12, further comprising: in accordance with the determination that the first language of the content is different from the second language indicated by the profile associated with the first client device, providing the machine-translated version of the content in the second language to the first client device.

Example 14: The method of any of examples 1-13, wherein: providing the machine-translated version of the content in the second language to the first client device includes providing an original-language option to the first client device; and the method further comprises: receiving an indication from the first client device that the original-language option was selected; and in response to receiving the indication, providing the content in the first language to the first client device.

Example 15: A system comprising one or more processors of a server and a memory storing instruction that, when executed by the one or more processors, cause the server to perform any of the methods of examples 1-14.

Example 16: A non-transitory computer readable storage medium storing instructions that, when executed by a server, cause the server to perform any of the methods of examples 1-14.

The foregoing description has been described with reference to specific implementations. However, the illustrative discussions above are not intended to be exhaustive or to limit the claims to the precise forms disclosed. Many variations are possible in view of the above teachings. The implementations were chosen and described to best explain principles of operation and practical applications, to thereby enable others skilled in the art.

The various drawings illustrate a number of elements in a particular order. However, elements that are not order dependent may be reordered and other elements may be combined or separated. While some reordering or other groupings are specifically mentioned, others will be obvious to those of ordinary skill in the art, so the ordering and groupings presented herein are not an exhaustive list of alternatives.

As used herein: the singular forms “a”, “an,” and “the” include the plural forms as well, unless the context clearly indicates otherwise; the term “and/or” encompasses all possible combinations of one or more of the associated listed items; the terms “first,” “second,” etc. are only used to distinguish one element from another and do not limit the elements themselves; the term “if” may be construed to mean “when,” “upon,” “in response to,” or “in accordance with,” depending on the context; and the terms “include,” “including,” “comprise,” and “comprising” specify particular features or operations but do not preclude additional features or operations.

What is claimed is:

1. A system comprising a server including one or more processors and memory storing one or more programs to be executed by the one or more processors, the one or more programs including instructions for:
obtaining content in a first language;
before providing the content to a first client device, receiving a first request from the first client device to view the content, wherein the first request is associated with a second language selected by a user operating the first client device;
in response to receiving the first request, determining that the first language of the content is different from the second language associated with the first request; and
in accordance with the determination that the first language of the content is different from the second language associated with the first request:
obtaining a machine-translated version of the content in the second language; and
providing the machine-translated version of the content in the second language to one or more client devices.

2. The system of claim 1, wherein the one or more programs further include instructions for:
storing the machine-translated version of the content in the second language in a storage of the server;
receiving a second request from a second client device to view the content, wherein the second request is associated with the second language;
in response to receiving the second request:
determining that the first language of the content is different from the second language associated with the second request; and
determining that the storage of the server includes the machine-translated version of the content in the second language; and
in accordance with the determination that the first language of the content is different from the second language associated with the second request and the determination that the storage of the server includes the machine-translated version of the content in the second language:
providing the machine-translated version of the content in the second language to the second client device.

3. The system of claim 1, wherein the first request is an Nth request to view the content, and the one or more programs further include instructions for:
in response to receiving the first request, determining that N is greater than or equal to a predetermined threshold for obtaining a machine translation, wherein the predetermined threshold is at least two; and
obtaining the machine-translated version of the content in the second language is further in accordance with the determination that N is greater than or equal to the predetermined threshold.

4. The system of claim 3, wherein the one or more programs further include instructions for adjusting the predetermined threshold based on a cost associated with obtaining the machine-translated version of the content in the second language.

5. The system of claim 1, wherein the machine-translated version of the content in the second language is obtained from a machine-translation algorithm based on one or more machine learning processes that are trained using content received at the server.

6. The system of claim 1, wherein:
the instructions for obtaining the content in the first language include instructions for obtaining user-submitted content from a third client device; and
the one or more programs further include instructions for determining that the user-submitted content is in the first language based on an association of the first language with the third client device.

7. The system of claim 1, wherein:
the one or more programs further include instructions for, in response to receiving the first request, determining that the storage of the server does not include a machine-translated version of the content in the second language; and
obtaining the machine-translated version of the content in the second language is further in accordance with the determination that the storage of the server does not include a machine-translated version of the content in the second language.

8. The system of claim 1, wherein the one or more programs further include instructions for, prior to receiving the first request from the first client device:
receiving, from the first client device, selection of the second language as the selected language for the first client device; and
assigning the second language to a profile associated with the user operating the first client device based on the selection of the second language;
wherein the association of the first request and the second language is based on the second language being assigned to the profile associated with the user operating the first client device.

9. The system of claim 1, wherein the one or more programs further include instructions for, prior to receiving the first request from the first client device:
receiving, from the first client device, selection of a locale of the first client device; and
assigning the second language to a profile associated with the user operating the first client device based on the selection of the locale of the first client device;
wherein the association of the first request and the second language is based on the second language being assigned to the profile associated with the user operating the first client device.

10. The system of claim 1, wherein the one or more programs further include instructions for:
subsequent to receiving the first request, obtaining an update to the content in the first language; and
in response to obtaining the update to the content in the first language and prior to receiving any subsequent requests to view the content:
obtaining a machine-translated version of the update to the content in the second language; and
storing the machine-translated version of the update to the content in the second language in the storage of the server.

11. The system of claim 1, wherein the one or more programs further include instructions for:
in response to receiving the first request, providing the content in the first language to the first client device.

12. The system of claim 11, wherein:
the instructions for providing the content in the first language to the first client device include instructions for providing a machine-translation option to the first client device; and
the one or more programs further include instructions for:
receiving an indication from the first client device that the machine-translation option was selected;
in response to receiving the indication, obtaining a non-cached machine-translated version of the content in the second language; and
providing the non-cached machine-translated version of the content in the second language to the first client device.

13. The system of claim 1, wherein the one or more programs further include instructions for:
in accordance with the determination that the first language of the content is different from the second language indicated by a profile associated with the first client device, providing the machine-translated version of the content in the second language to the first client device.

14. The system of claim 13, wherein:
the instructions for providing the machine-translated version of the content in the second language to the first client device include instructions for providing an original-language option to the first client device; and
the one or more programs further include instructions for:
receiving an indication from the first client device that the original-language option was selected; and
in response to receiving the indication, providing the content in the first language to the first client device.

15. A method of selectively pre-translating content at a server including one or more processors and memory, the method comprising:
obtaining content in a first language;
before providing the content to a first client device, receiving a first request from the first client device to view the content, wherein the first request is associated with a second language selected by a user operating the first client device;
in response to receiving the first request, determining that the first language of the content is different from the second language associated with the first request;
in accordance with the determination that the first language of the content is different from the second language associated with the first request:
obtaining a machine-translated version of the content in the second language; and
providing the machine-translated version of the content in the second language to one or more client devices.

16. The method of claim 15, further comprising:
storing the machine-translated version of the content in the second language in a storage of the server;
receiving a second request from a second client device to view the content, wherein the second request is associated with the second language;
in response to receiving the second request:
determining that the first language of the content is different from the second language associated with the second request; and
determining that the storage of the server includes the machine-translated version of the content in the second language; and
in accordance with the determination that the first language of the content is different from the second language associated with the second request and the determination that the storage of the server includes the machine-translated version of the content in the second language:
providing the machine-translated version of the content in the second language to the second client device.

17. The method of claim 15, wherein the first request is an Nth request to view the content, and the method further comprises:
in response to receiving the first request, determining that N is greater than or equal to a predetermined threshold for obtaining a machine translation, wherein the predetermined threshold is at least two; and
obtaining the machine-translated version of the content in the second language is further in accordance with the determination that N is greater than or equal to the predetermined threshold.

18. The method of claim 17, further comprising adjusting, at the server, the predetermined threshold based on a cost associated with obtaining the machine-translated version of the content in the second language.

19. The method of claim 15, wherein the machine-translated version of the content in the second language is obtained from a machine-translation algorithm based on one or more machine learning processes that are trained using content received at the server.

20. A non-transitory computer readable storage medium storing one or more programs configured for execution by a computer system having a display, one or more processors, and memory, the one or more programs comprising instructions for:
obtaining content in a first language;
before providing the content to a first client device, receiving a first request from the first client device to view the content, wherein the first request is associated with a second language selected by a user operating the first client device;
in response to receiving the first request, determining that the first language of the content is different from the second language associated with the first request; and
in accordance with the determination that the first language of the content is different from the second language associated with the first request:
obtaining a machine-translated version of the content in the second language; and providing the machine-translated version of the content in the second language to one or more client devices.
